(19) United States
(12) Patent Application Publication
(10) Pub. No.: US 2026/0358525 A1
(43) Pub. Date: Nov. 12, 2026

(54) WATER BED SEISMIC IMAGING USING WATER PRESSURE DENOISING

(71) Applicant: SCHLUMBERGER TECHNOLOGY CORPORATION, Sugar Land, TX (US)

(72) Inventors: Paal KRISTIANSEN, Oslo (NO); Federico Eugenio SOKOLOWSKI, Crawley (GB); Andreas Tyasbudi WALUYO, Jakarta (ID)

(21) Appl. No.: 19/142,245

(22) PCT Filed: May 2, 2024
(86) PCT No.: PCT/US2024/027489

§ 371 Date: Jun. 23, 2025

Related U.S. Application Data
(60) Provisional application No. 63/499,855, filed on May 3, 2023.

(51) Int. Cl. G01V 1/36; G01V 1/18

(52) U.S. Cl. CPC G01V 1/362; G01V 1/189; G01V 2210/1427; G01V 2210/144; G01V 2210/38

(57) ABSTRACT

A method can include receiving data for a subsurface region as acquired using sensor assemblies disposed at seabed locations, where each sensor assembly includes a multi-component seabed sensor that acquires multi-component seabed seismic data and a water pressure sensor that acquires water pressure data; generating a noise model for one of the seabed locations using the water pressure data acquired by the sensor assembly disposed at the one of the seabed locations; adaptively subtracting the noise model from the multi-component seabed seismic data acquired by the sensor assembly disposed at the one of the seabed locations to generate noise attenuated seabed seismic data; and generating an image of at least a portion of the subsurface region using the noise attenuated seabed seismic data.

### RELATED APPLICATIONS

This application claims priority to and the benefit of a U.S. Provisional Application having Ser. No. 63/499,855, filed 3 May 2023, which is incorporated by reference herein in its entirety.

### BACKGROUND

Reflection seismology finds use in geophysics to estimate properties of subsurface formations. Reflection seismology may provide seismic data representing waves of elastic energy as transmitted by P-waves and S-waves, in a frequency range of approximately 1 Hz to approximately 100 Hz. Seismic data may be processed and interpreted to understand better composition, fluid content, extent and geometry of subsurface rocks.

### SUMMARY

A method can include receiving data for a subsurface region as acquired using sensor assemblies disposed at seabed locations, where each sensor assembly includes a multi-component seabed sensor that acquires multi-component seabed seismic data and a water pressure sensor that acquires water pressure data; generating a noise model for one of the seabed locations using the water pressure data acquired by the sensor assembly disposed at the one of the seabed locations; adaptively subtracting the noise model from the multi-component seabed seismic data acquired by the sensor assembly disposed at the one of the seabed locations to generate noise attenuated seabed seismic data; and generating an image of at least a portion of the subsurface region using the noise attenuated seabed seismic data.

A system can include a processor; memory operatively coupled to the processor; and processor-executable instructions stored in the memory to instruct the system to: receive data for a subsurface region as acquired using sensor assemblies disposed at seabed locations, where each sensor assembly includes a multi-component seabed sensor that acquires multi-component seabed seismic data and a water pressure sensor that acquires water pressure data; generate a noise model for one of the seabed locations using the water pressure data acquired by the sensor assembly disposed at the one of the seabed locations; adaptively subtract the noise model from the multi-component seabed seismic data acquired by the sensor assembly disposed at the one of the seabed locations to generate noise attenuated seabed seismic data; and generate an image of at least a portion of the subsurface region using the noise attenuated seabed seismic data.

A seabed sensor assembly can include a multi-component seabed sensor that acquires multi-component seabed seismic data; a water pressure sensor that acquires water pressure data; noise model generation circuitry that generates a noise model using the water pressure data; adaptive subtraction circuitry that adaptively subtracts the noise model from the multi-component seabed seismic data to generate noise attenuated seabed seismic data; and an interface for transmission of the noise attenuated seabed seismic data.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a system and an example of a geologic environment;

FIG. 2 illustrates examples of systems and techniques;

FIG. 3 illustrates examples of a survey system, a node, a method and a computing system;

FIG. 4 illustrates examples of a node, an accelerometer and a hydrophone;

FIG. 5 illustrates an example of a method;

FIG. 6 illustrates an example of a method and an example of an assembly;

FIG. 7 illustrates examples of images;

FIG. 8 illustrates examples of images; and

FIG. 9 illustrates examples of components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

As mentioned, reflection seismology finds use in geophysics to estimate properties of subsurface formations. Reflection seismology can provide seismic data representing waves of elastic energy, as transmitted by P-waves and S-waves, in a frequency range of approximately 1 hertz (Hz) to approximately 100 Hz or optionally less than 1 Hz and/or optionally more than 100 Hz. Seismic data may be processed and interpreted to understand better composition, fluid content, extent and geometry of subsurface rocks.

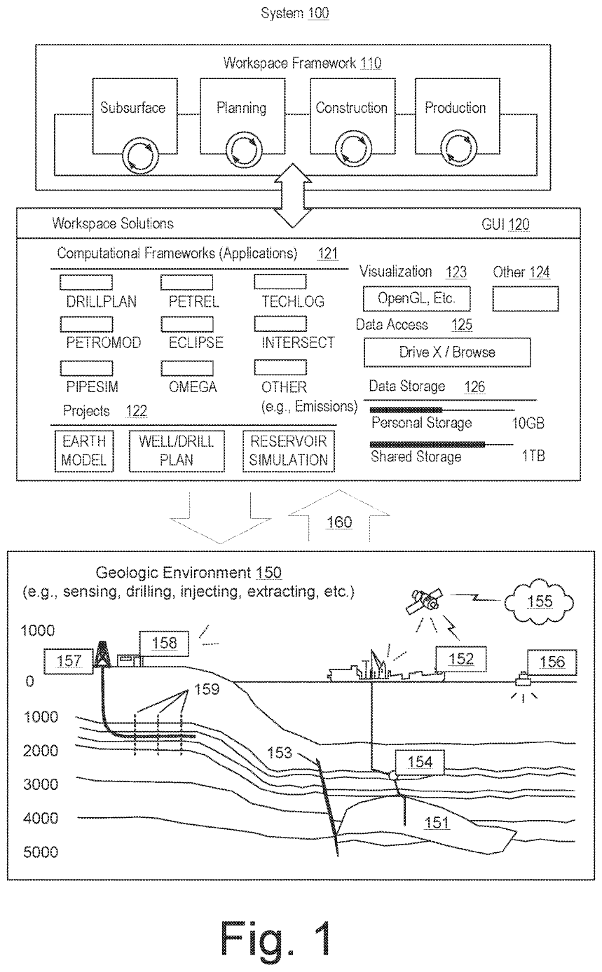

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, INTERSECT, PIPESIM and OMEGA frameworks (SLB, Houston, Texas). As to another type of framework, consider, for example, an emissions framework (EF), which may be operable in combination with one or more other frameworks to make determinations as to emissions (e.g., of one or more field operations, etc.). In such an example, an EF may provide feedback such that another framework can operate on output of the EF, for example, to revise a plan, revise a control scheme, etc., which may be in a manner that aims to reduce one or more types of emissions and/or other impact from an activity, etc.

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive E&P environment (SLB, Houston, Texas) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The OMEGA framework includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. The OMEGA framework also includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages. Examples of such software packages include the PETREL framework. As an example, a system or systems may utilize a framework such as the DELFI framework (SLB, Houston, Texas). Such a framework may operatively couple various other frameworks to provide for a multi-framework workspace. As an example, the GUI 120 of FIG. 1 may be a GUI of the DELFI framework.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 milliseconds (ms). Given a speed of sound in a medium or media, a sample rate may be converted to an approximate distance. For example, the speed of sound in rock may be on the order of around 5 kilometers (km) per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator does not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results too are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator (SLB, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The MANGROVE simulator (SLB, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

As mentioned, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

As mentioned, reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than 1 Hz and/or optionally more than 100 Hz). Seismic data may be processed and interpreted, for example, to understand better composition, fluid content, extent and geometry of subsurface rocks.

Digital images of a subsurface region of the Earth can be generated using digital seismic data acquired using reflection seismology as part of a seismic survey. A digital image can show subterranean structure, for example, as related to one or more of exploration for petroleum, natural gas, and mineral deposits. As an example, reflection seismology can include determining time intervals that elapse between initiation of a seismic wave at a selected shot point (e.g., the location where an explosion generates seismic waves) and the arrival of reflected or refracted impulses at one or more seismic detectors (e.g., sensing of seismic energy at one or more seismic receivers). As an example, a seismic air gun can be used to initiate seismic waves. As an example, one or more electric vibrators or falling weights (e.g., thumpers) may be employed at one or more sites. Upon arrival at the detectors, the amplitude and timing of seismic energy waves can be recorded, for example, as a seismogram (e.g., a record of ground vibrations).

In various regions of the Earth, the material density (e.g., rock density) increases with depth. Seismic energy waves can be initiated at a shot point (or points) at or near the surface where a portion of the seismic energy, as waves, may reach one or more receiving points. Material properties and structural organization of materials (e.g., as objects, layers, etc.) can affect seismic energy waves in one or more manners. Received seismic energy waves can be utilized to determine one or more types of material properties and/or structural organization of one or more types of materials. As with sound traveling through air or water, seismic energy waves can be attenuated as they pass through subsurface materials, which may include air, water, hydrocarbons, rock, etc. Such attenuation can occur in a manner that is dependent on material properties of such materials.

Interpretation of the depths and media reached by seismic energy waves can depend on geometry of a seismic survey, for example, on the distance between shot points and receiving points, as well as densities of media. Results of a seismic survey may be in digital form (e.g., digital data) as stored in memory of a computing device where display circuitry (e.g., a graphics processor, a video processor, etc.) can render the digital data to a display in the form of a cross-sectional image of subsurface structures as if cut by a plane through the shot point, the detector, and a reference point such as the Earth's center. As an example, digital image processing can involve receiving seismic data as digital data, processing the seismic data via one or more techniques, and rendering processed seismic data to a display as an image of a region of the Earth that can show structural features of the Earth that otherwise are not visible from an observer standing on the surface of the Earth.

A seismic survey can be defined with respect to a region of the Earth and, for example, a manner of acquisition of seismic data. As an example, a survey may be two-dimensional, three-dimensional, four-dimensional, etc. Dimensions include one or more spatial dimensions and optionally one or more temporal dimensions (e.g., repeating a survey for a region at different points in time). As to a 2D survey, a grid may be considered dense if the line spacing (e.g., of receivers) is less than about 400 meters (m). As to a 3D spatial survey, in comparison to a 2D spatial survey, it may help to elucidate true structural dip (e.g., a 2D survey may give apparent dip), it may provide more and better stratigraphic information, it may provide a map view of reservoir properties, it may provide a better areal mapping of fault patterns and connections and delineation of reservoir blocks, it may provide better lateral resolution (e.g., 2D may suffer from a cross-line smearing, or Fresnel zone, problem).

As to data sets, a 3D spatial seismic data set can be a cube or volume of data. As an example, a 2D spatial seismic data set can be a panel of data. To interpret 3D seismic data, a method can process the “interior” of the cube (e.g., seismic cube) using one or more processors of computing equipment. As an example, a 3D seismic data set can range in size from a few tens of megabytes to several gigabytes or more.

As to a 3D seismic cube, a point can have an (x, y, z) coordinate and a data value. A coordinate can be a distance from a particular corner of the cube. A 3D seismic data volume is like a room-temperature example (e.g., where temperature differs in a cube shaped room), however, rather than a height of a room, a height or vertical axis can be in terms of a two-way traveltime, which may be a proxy for depth. In such an example, the 3D seismic cube is still a spatial cube because the data therein correspond to the same survey where, rather than depth, two-way traveltime (TWT) is utilized, which, can be, in general, a proxy for depth.

And, in contrast to room-temperature, data values can be seismic amplitudes (e.g., amplitudes of seismic energy waves). A 3D seismic data set can be, for example, a box full of electronically determined numbers where each number represents a measurement (e.g., amplitude of a seismic energy wave, etc.). In a 3D seismic data set, amplitudes may be rendered as data values in the form of one or more images for slices through the 3D seismic data set where, for example, in grayscale, dark and light image bands in the sections are related to rock boundaries.

Reflection seismology can be implemented as a technique that detects “edges” of materials in the Earth. An image generated utilizing reflection seismology can show such edges of materials, which can be equated to positions in the Earth such that one may know where an edge of a material is in the Earth. For example, where the edge corresponds to a hydrocarbon reservoir, a method can include drilling to the reservoir in a manner guided by the position of the edge. As an example, a drilling process can be manual, semi-automated or automated where positional information as to an edge of a material in the Earth can be utilized to guide drilling equipment that forms a bore in the Earth where the bore may be directed to the edge or to a region that is defined at least in part by the edge. Where reflection seismology is improved, such an “edge” may be detected more readily and/or with greater accuracy (e.g., resolution), which, in turn, can improve one or more field processes such as a drilling process.

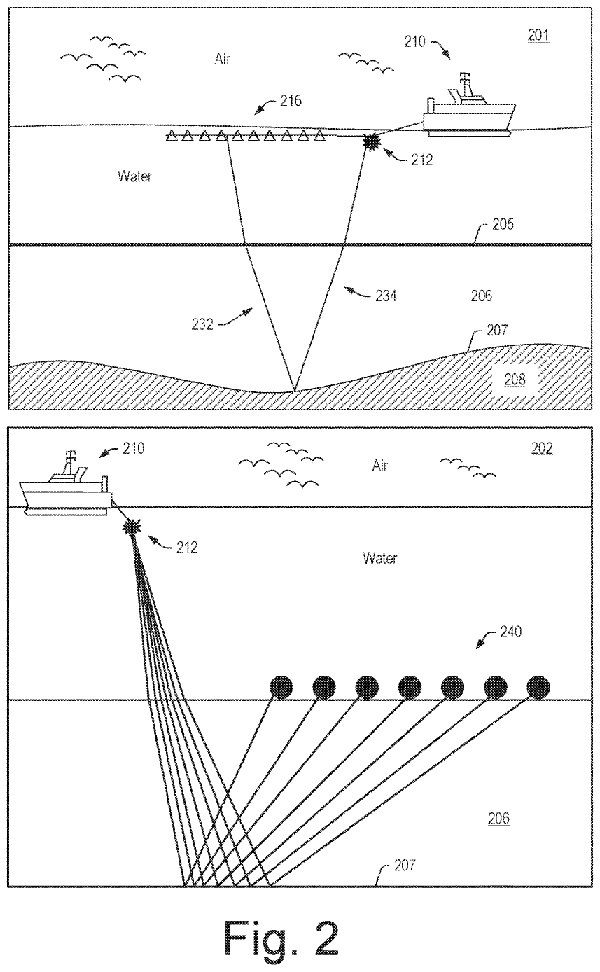

FIG. 2 shows examples of a simplified schematic views of marine seismic acquisition systems 201 and 202 where a vessel 210 can tow one or more sources 212. As shown, the system 201 includes a series of receivers 216 that can be towed by the vessel 210. For example, the receivers 216 can be part of a streamer or streamers. In the example system 201, at least one of the one or more sources 212 can emit energy at a location and at least one of the receivers 216 can receive energy at a location. The emitted energy can be at least in part along a path Of the downgoing energy 232 and the received energy can be at least in part along a path of the upgoing energy 234. As shown, the energy can be transmitted through water, at least partially through a water/material surface interface 205 and into a subsurface region that can include multiple layers of material 206 and 208 where an interface 207 exists between the layers of material 206 and 208, noting that there may be more than two layers of material and hence more than a single interface.

As to the example system 202, it includes ocean bottom receivers (OBRs) 240, which can be positioned on the water/material surface interface 205 (e.g., a seafloor, seabed, ocean bottom, sea bottom, etc.). As an example, a common shot approach may be utilized. As an example, the vessel 210 can tow the one or more sources 212 at or below an air-water interface where the OBRs 240 can be positioned on a water/material surface interface 205 (e.g., a seafloor, seabed, ocean bottom, sea bottom, etc.). As shown, energy of at least one of the sources 212 passes through the water, at least partially through the interface 205 and then into the layer of material 206 where a portion of the energy is reflected at the interface 207 (e.g., a reflector). As shown, energy can reflect off the interface and progress upwardly to one or more of the OBRs 240, which record the energy. As an example, the OBRs 240 may include ocean bottom nodes (OBNs) and/or one or more ocean bottom cables (OBCs). As an example, an OBR can include a fiber optic or fiber optics.

When seismic traces of a gather come from a single shot and many receivers, they can form a common shot gather; whereas, a single receiver with many shots can form a common receiver gather. A shot gather is a plot of traces with respect to line distance (e.g., an inline or a crossline series of receivers) with respect to time. Such a plot may be referred to as an image, which includes information about a subsurface region; noting that traces may be processed to generate one or more other types of images of a subsurface region.

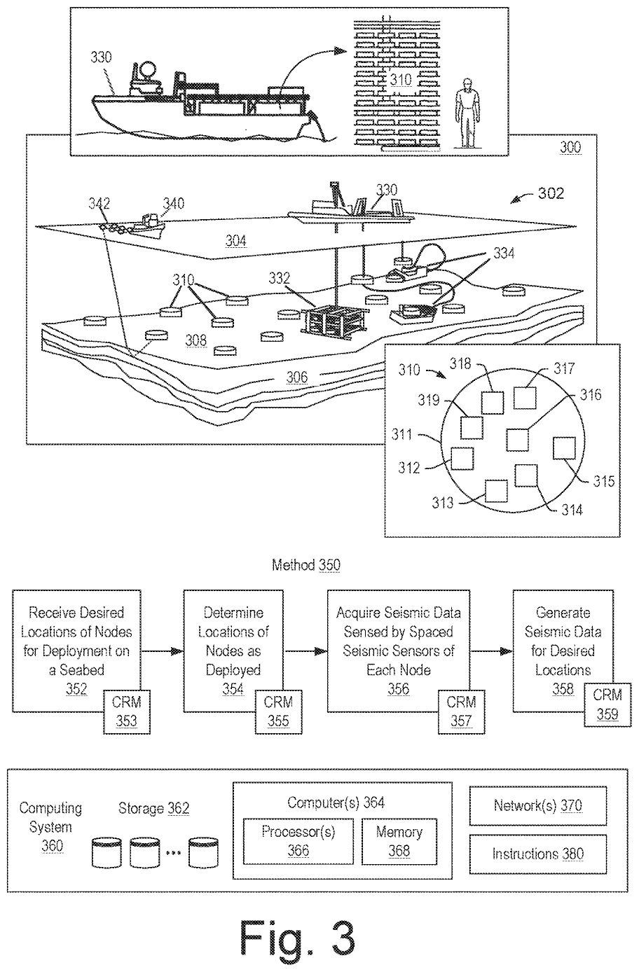

FIG. 3 shows a survey system 300 for acquisition of information in a geologic environment 302 that includes an air-water surface 304, a formation 306 and a seabed 308 where nodes 310 are positioned on the seabed 304. Equipment may be utilized to position the nodes 310 on the seabed 304 and retrieve the nodes 310 from the seabed 304. Such equipment may include one or more vessels 330, one or more carriers 332 and one or more vehicles 334, which may be autonomous, semi-autonomous, etc. (remotely operated vehicles (ROVs), etc.). The survey system 300 may include a seismic source vessel 340 that includes one or more seismic sources 342. The seismic source vessel 340 may travel a path while, at times, emitting seismic energy from the one or more sources 342. In such an approach, the nodes 310 can receive portions of the seismic energy, which can include portions that have travelled through the formation 306. Analysis of received seismic energy by the nodes 310 may reveal features of the formation 306.

In FIG. 3, the vessel 330 is shown as including nodes 310 as cargo arranged on racks. The nodes 310 can be deployed to form an array. An array of nodes may be cabled or un-cabled. A cable may be relatively light weight and utilized to deploy a node receiver line with nodes coupled to the cable at spaced intervals. A rack can be utilized to securely store nodes in slots along multiple rows and columns. An individual slot may include a communications portal that can establish communication via contact(s) and/or contactless/wireless with an individual node seated in the individual slot for download of information, etc. A rack can include charger circuitry that can charge one or more batteries of an individual node seated in an individual slot. A node can be sealed such that components (circuitry, one or more batteries, etc.) are not exposed to water when the node is deployed on an underwater bed. A seal may be a hermetic seal that aims to prevent passage of air and/or water. A seal or seals can aim to prevent intrusion of water from an exterior region to an interior region of a node. Such a node can be considered to be water-tight. A sealed node can be a self-contained piece of equipment that can sense information independent of other equipment when positioned on an underwater surface that may be a seabed.

A rack may be dimensioned in accordance with shipping container dimensions such as about 3 meters by about 7 meters by about 3 meters. As shown in FIG. 3, with reference to a silhouette of a person that is about 1.8 meters in height, a node may be about a meter or less in diameter and about half a meter in height or less.

In FIG. 3, the one or more sources 342 may be an air gun or air gun array (a source array) and/or one or more other types of sources. A source can produce a pressure signal that propagates through water into a formation where elastic waves are formed through interaction with features (structures, fluids, etc.) in the formation. The pressure signal, often referred to as acoustic waves, can be characterized by pressure changes and a particle displacement in a direction of which the acoustic wave travels. Elastic waves can be characterized by a change in local stress in material and a particle displacement. Elastic wavefields include compression and shear waves; noting that shear waves do not propagate in water. As such, for sensing of shear waves, a receiver (e.g., a sensor such as a geophone) can be placed directly or indirectly in contact with a formation; whereas, for pressure waves, which can travel through water, a receiver (e.g., a sensor such as a hydrophone) can be positioned in water.

As an example, a receiver unit or receiver assembly can include co-located receivers such as, for example, a geophone that is co-located with a hydrophone. As to co-location, in general, closer may be better, though co-location can be defined as being carried by the same equipment (e.g., a common OBN, a common OBC, etc.). In general, co-location for a geophone and a hydrophone means that they are within approximately 10 meters of one another. Collectively, acoustic and elastic waves may be referred to as a seismic wavefield.

Material in a formation may be characterized by one or more physical parameters such as density, compressibility, and porosity. In the geologic environment 302 of FIG. 3, energy emitted from the one or more sources 342 can be transmitted to the formation 306; however, elastic waves that reach the seabed 308 will not propagate back into the water. Such elastic waves may be received by sensors of the nodes 310. The nodes 310 can include motion sensors that can measure one or more of displacement, velocity and acceleration. A motion sensor may be a geophone, an accelerometer, etc. As to pressure waves, the nodes 310 can include pressure wave sensors such as hydrophones.

In FIG. 3, the nodes 310 can include sensors for acquiring seismic wavefield information at the seabed 308. Each of the nodes 310 can include one or more hydrophones and/or one or more motion sensors (e.g., one or more geophones, one or more accelerometers, etc.). Each of the nodes 310 can include a sealed housing and, within the sealed housing, at least one battery and spaced seismic sensors electrically powered by the at least one battery. The spaced seismic sensors can be spaced by a distance that is less than a dimension of the sealed housing. As to a water pressure sensor, it can be exposed to water. For example, a hydrophone can be exposed to water such that it can sense water pressure.

As an example, a water pressure sensor may be within a node housing and in fluid communication with water (e.g., an exterior environment) and/or a pressure sensor may extend away from a node housing to be in fluid communication with water. A node that includes a water pressure sensor can still have a sealed housing such that various components are in a sealed environment where a water pressure sensor may include a sealed fitting such that at least a portion of the water pressure sensor can be in fluid communication water for water pressure sensing.

A node can include various types of circuitry. Such circuitry can include circuitry that can digitize (analog to digital conversion ADC circuitry) and can include circuitry that can record signals (a microcontroller, a processor, etc., operatively coupled to memory). Each of the nodes 310 can include a housing 311, sensors 312 and 313, one or more microcontrollers or processors 314, one or more batteries 315, memory 316, ADC circuitry 317, a compass 318, communication circuitry 319, etc. Various components of a node may be operatively coupled via wires, connectors, etc. A node can include one or more circuit boards (printed circuit boards, etc.) that can provide for electrical connections between various components, etc.

After deployment, one or more acoustic techniques may be utilized to determine node locations. A technique may employ acoustic pinging where acoustic pingers emit relatively high-frequency pings that are substantially above the maximum frequency of interest for seismic applications. Such relatively high-frequency acoustic signals can be picked up by one or more seismic sensors. Triangulation or one or more other techniques may be utilized to determine node locations for nodes deployed on an underwater surface such as a seabed.

Nodes may be utilized to acquire information spatially and temporally such as in a time-lapse seismic survey, which may be a four-dimensional seismic survey (4D seismic survey). A seismic image of a formation may be made for a first survey and a seismic image of the formation may be made for a second survey where the first and second surveys are separated by time (lapse in time). In such an approach, a comparison of the images can infer changes in formation properties that may be tied to production of hydrocarbons, injection of water or gas, etc.

A first survey may be referred to as a baseline survey, while a subsequent survey may be referred to as a monitor survey. To minimize artifacts in differences between seismic images from successive lapses, a monitor survey may aim to replicate a configuration of a corresponding baseline survey. Where nodes are utilized at various positions on a seabed for a baseline survey, a monitor survey may aim to place nodes on the seabed in a manner that replicates the various positions of the nodes of the baseline survey. For the monitor survey, the nodes may be the same nodes, include some of the same nodes, include some different nodes or may be different nodes. A service may have a stock of nodes that can be utilized for various surveys where once a survey is complete, the nodes are retrieved, transported and positioned for another survey. Such a service may update, replace, etc., nodes from time to time.

A position to within a few meters of accuracy of one or more nodes may be determined via one or more of GPS, an acoustic positioning system (a short-baseline (SBL) or ultra-short baseline (USBL) acoustic system), and one or more other types of systems.

As an example, a node may include sensor circuitry for acquiring measurements of a seismic pressure wavefield and its gradient; consider sensor circuitry that can measure a seismic pressure wavefield and its gradient in vertical and crossline directions.

As an example, a node can include point-receiver circuitry. A point-receiver approach can combine hydrophones with tri-axial microelectromechanical system (MEMS) accelerometers. In such an approach, the MEMS accelerometers can measure a substantial bandwidth of particle acceleration due to seismic wavefields. Measurements of particle acceleration can be directly related to a gradient in a pressure wavefield. A node may include the ISOMETRIX technology, which includes point-receiver circuitry (SLB, Houston, Texas).

FIG. 3 also shows a method 350 that includes a reception block 352 for receiving desired locations of nodes for deployment on a seabed of a seismic survey where each of the nodes includes a sealed housing and, within the sealed housing, at least one battery and spaced seismic sensors electrically powered by the at least one battery; a determination block 354 for determining locations of the nodes as deployed on the seabed where at least some of the determined locations differ from their corresponding desired locations; an acquisition block 356 for acquiring seismic data sensed by the spaced seismic sensors of the nodes where the acquired seismic data corresponds to the determined locations; and a generation block 358 for, based at least in part on the acquired seismic data, a spacing of the spaced seismic sensors and the desired locations, generating seismic data for the desired locations. As explained, a node can also include a water pressure sensor, which can be electronically coupled to circuitry and exposable to water for water pressure sensing.

The method 350 is shown in FIG. 3 in association with various computer-readable media (CRM) blocks 353, 355, 357 and 359. Such blocks generally include instructions suitable for execution by one or more processors (or cores) to instruct a computing device or system to perform one or more actions. While various blocks are shown, a single medium may be configured with instructions to allow for, at least in part, performance of various actions of the method 350. A computer-readable medium (CRM) may be a computer-readable storage medium that is not a carrier wave, that is not a signal and that is non-transitory.

FIG. 3 also shows a computing system 360, which can include one or more information storage devices 362, one or more computers 364, one or more network interfaces 370 and instructions 380. As to the one or more computers 364, each computer may include one or more processors (or processing cores) 366 and memory 368 for storing instructions executable by at least one of the one or more processors. A computer may include one or more network interfaces (wired or wireless), one or more graphics cards, a display interface (wired or wireless), etc. A system may include one or more display devices (optionally as part of a computing device, etc.). Memory can be a computer-readable storage medium. A computer-readable storage medium is not a carrier wave, is not a signal and is non-transitory.

A geophone can be a sensor configured for seismic acquisition, whether onshore and/or offshore, that can detect velocity produced by seismic waves and that can transform motion into electrical impulses. A geophone may be configured to detect motion in a single direction (e.g., a 1D geophone). A geophone may be configured to detect motion in a vertical direction. Three mutually orthogonal geophones may be used in combination to collect so-called three-component (3C) seismic data (e.g., a 3D geophone).

A hydrophone may be a sensor configured for use in detecting seismic energy in the form of pressure changes under water during marine seismic acquisition (e.g., water pressure sensing). A node may include at least one geophone that can provide for motion detection and at least one hydrophone that can provide for pressure detection. Data (analog and/or digital) may be transmitted from a node (via wire, wirelessly, etc.) for processing, etc. Four-component (4C) borehole or marine seismic data can be acquired using three orthogonally-oriented geophones (e.g., a 3D geophone) and a hydrophone within an ocean-bottom sensor (deployed in node-type system, a cable-type system, etc.). A 4C node in contact with the seabed (formation) can measure shear waves (geophone-based sensing) and can measure compressional waves (hydrophone-based sensing).

As explained, a source or source array may be activated periodically, such as about each 25 m (about at 10 second intervals) as towed by a vessel where the resulting sound wave travels into the Earth, which may be reflected back by one or more rock layers to one or more sensors, which may then be relayed as signals (data, information, etc.) to equipment.

Pressure data may be represented as “P” and velocity data may be represented as “Z”; noting, however, that the vertical component of a measured particle velocity vector may be denoted “V” and that “Z” may refer to a scaled, measured particle velocity. “V” may represent a measured velocity and “Z” may represent a scaling thereof.

As mentioned, a hydrophone can sense pressure information (P data) and a geophone may sense velocity information (V and/or Z data). A hydrophone may output signals, optionally as digital data for receipt by a system. A geophone may output signals, optionally as digital data for receipt by a system. The system 360 may receive P and VIZ data via one or more of the one or more network interfaces 370 and process such data via execution of the instructions 380 stored in the memory 368 as accessed by one or more of the one or more processors 366. The system 360 may store raw and/or processed data in one or more of the one or more information storage devices 362.

Referring again to the survey system 300 of FIG. 3, one of the nodes 310 may be connected to one or more other nodes of the nodes 310 via a cable. A vessel may include a cable that is operatively coupled to at least one node. In the survey system 300 of FIG. 3, nodes may be deployed according to a survey plan in a grid pattern; consider placement of nodes on a seabed according to an x, y grid where distance between adjacent nodes may be of the order of hundreds of meters. As shown in the survey system 300, the seismic source vessel 340 may be employed with the one or more sources 342 that can emit energy, which can, in turn, be received via one or more of the nodes 310.

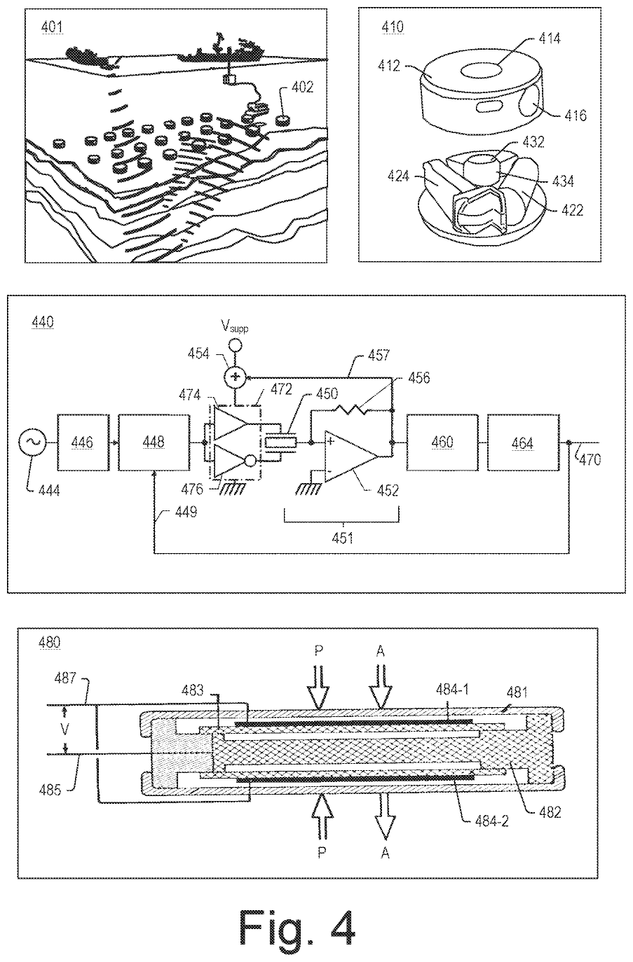

FIG. 4 shows a geologic environment 401 that includes nodes 402, a node 410, an accelerometer 440 and a hydrophone 480. As shown in FIG. 4, the node 410 can include a top cover 412, a communication antenna 414, an interface 416, one or more batteries 422, a recorder 424, a hydrophone sensor package 432 (e.g., exposable to water) and a geophone sensor package 434. The recorder 424 can record information acquired by the hydrophone sensor package 432 and/or the geophone sensor package 434. Information acquired by the node 410 may be transmitted via the communication antenna 414 to a receiver, which may be part of communication equipment carried by a vessel, etc. The node 410 may be positioned on a seafloor via a vehicle (a remotely operated vehicle, a robot, etc.).

As shown in FIG. 4, the nodes 402 may be positioned over a particular area of the seafloor as specified by a seismic survey plan. The nodes 402 may be positioned in a grid pattern. Such a grid pattern may specify a distance or distances between neighboring nodes. An array of nodes such as the nodes 402 may be referred to as a patch. Information acquired by nodes can be processed and analyzed to increase understanding of structures in a sub-seafloor environment.

One or more of the accelerometers 440 may be included in the geophone sensor package 434. As to the hydrophone sensor package 432, it can include a single pressure sensor or more than one pressure sensor.

As shown in FIG. 4, the accelerometer 440 can include a system clock generator 444, a jitter filter 446, a pulse generator 448, a return connection 449, a sensor 450, a charge amplifier 451, an adder 454, a resistor 456, an adder connection 457, an amplitude detector 460, a loop controller 464, a digital output 470 and logic 472 with complimentary drivers 474 and 476.

In FIG. 4, the accelerometer 440 can include a capacitive MEMS-based sensor. As illustrated in FIG. 4, the sensor 450 can include an armature and a pair of fixed position electrodes attached to the armature. A sensor may include a differential capacitor, in which a mobile electrode moves along a sensitive axis in response to an external acceleration.

The accelerometer 440 may be subjected to inertial forces caused by an external acceleration where a proof mass may be kept in an equilibrium position by electrostatic forces controlled via feedback circuitry. In FIG. 4, the amplitude detector 460 and the loop controller 464 can provide a substantially high gain where residual movement of a mobile mass with respect to its equilibrium position may be kept close to a null point. In such an approach, magnitude and direction of a net restoring force can be a difference between attractive forces working in opposite directions.

A type of noise, referred to as sampling noise, can be defined as KT/C noise (thermal noise), which may be introduced by switching and can degrade a dynamic range of a sensor. In FIG. 4, the accelerometer 440 can include the charge amplifier 451 configured with an input terminal that is continuously connected to a mobile electrode (during times in which the sensor 450 receives both actuation and activation voltages). In such an approach, sampling noise can be reduced in comparison to circuitry that does not include such a configuration of components.

In FIG. 4, the accelerometer 440 can include a constant charge drive for the sensor 450. The charge amplifier 451 of the accelerometer 440 can modulate, or adjust, actuation voltage based on a proof mass movement, which may thereby increase available signal-to-noise ratio. As shown in FIG. 4, a feedback network can be associated with the charge amplifier 451. An output terminal of the amplifier 452 can be connected via the adder connection 457 to the adder 454, which can combine an output signal from the amplifier 452 with a supply voltage Vₛᵤₚₚ. In such an arrangement, the supply voltage that is applied to the logic 472, from the adder 454, can be modulated according to a sensed signal that as available at the output terminal of the amplifier 452; and as a result, the actuation force can be independent of the proof mass movement.

A sensor package may include a three component (3C) particle motion sensor assembly; consider a 3C accelerometer assembly. Such an assembly may acquire inline (x), crossline (y) and vertical (z) particle acceleration measurements; consider an accelerometer assembly that includes microelectromechanical system (MEMS) sensor units that sense accelerations along respective inline (x), crossline (y) and vertical (z) axes. A grid of a survey may be defined via a corresponding coordinate system (at least in inline (x) and crossline (y) directions). In a package, orientations of MEMS sensor units may be appropriately varied for purposes of alignment with corresponding axes.

In FIG. 4, as shown in an approximate cross-sectional view, the hydrophone 480 can include a sheath 481, a core 482, an electrode 483 and at least one piezoelectric element 484-1 and 484-2, which may be a ceramic-based piezoelectric element or elements. As shown, a potential (V) may be measured across wires 485 and 487 where the potential (V) varies based at least in part on response of the at least one piezoelectric element 484-1 and 484-2 to external forces such as pressure and/or acceleration.

A piezoelectric material can produce an electrical potential when it is subjected to physical deformation. A piezoelectric material can include a crystalline structure (quartz, tourmaline, a poly-crystalline ceramic, etc.). A lead zirconate titanate (PZT) may be utilized.

A hydrophone can include a plate of piezoelectric ceramic placed on an elastic electrode. In such an approach, the active element can be deformed by pressure variations in surrounding water and produce a voltage collected between the electrode and a terminal bonded to the other face. The electrode can rest on a metallic core that supports its ends and that may also limit its maximum deformation (to avoid damage to the ceramic). A hydrophone can be configured to preserve integrity even where it may be accidentally submitted to high pressures.

As the active element has mass, it can produce a voltage when it is subjected to acceleration. To diminish the effect of acceleration, a hydrophone can be assembled with elements that may be paired, as shown in FIG. 4 (see elements 484-1 and 484-2 with respect to the direction of acceleration). In such an arrangement, voltage produced by acceleration can cancel whereas voltage produced by pressure can add. While voltage is mentioned, a hydrophone may be configured with circuitry such that current provides an indication of sensed pressure.

As an example, a method can include denoising PS-wave data using co-located hydrophone measurements. As explained, noise can exist in PS-wave data where to improve imaging of a subsurface geologic region, denoising can be applied. For example, a process can aim to remove at least some of the recorded noise in PS-wave data by using a measured pressure component in water as a noise model and by performing adaptive subtraction.

As explained, ocean bottom seismic (OBS) data can be acquired using 3-component sensors and pressure sensors. In an OBS workflow, P-waves reflected from the subsurface as well as converted shear waves (PS-waves) can be processed to generate a corresponding image of a subsurface region. In such a workflow, recorded data can be separated into data which primarily contain one of the wave modes. As to other energy in the recorded data, as it will not contribute to the imaging of a particular wave mode, it can be suppressed via denoising.

Pressure measurements in water using, for example, hydrophones, do not record shear-waves and therefore the energy recorded by such sensors can be regarded as noise within the recorded gathers to be processed as PS-wave data. In theory, the pressure measurements in the water can be a relatively complete noise model that can be adaptively subtracted from recorded PS-data.

Adaptive subtraction can be utilized to modify a noise model to better match noise present in data. For example, adaptive subtraction can aim to adjust for inaccuracies in a noise model or noise models. In various instances, there can be differences in phase between data and a noise model that can be taken into account.

As an example, a match function can be utilized that takes as input both a noise model and data that includes noise. In such an example, adaptive subtraction can be constrained to perform two tasks simultaneously: preserve some features of the input noise model while also improving the match with the noisy data. Generally, a match function varies in time and one or more spatial dimensions to correct for errors that may also vary in one or more of such manners.

One or more types of adaptive subtraction techniques may be applied, which may be modified from adaptive subtraction as used on seismic data in a prestack or a post-stack manner with respect to multiple attenuation. However, as explained, the aim is not to attenuate multiples, rather the aim is to denoise OBS data, as acquired using co-located sensors.

In the context of multiple attenuation, multiples are duplicate echoes caused by a variety of different factors that can be attenuated in processing such that primary reflections are retained for imaging. In processing, to attenuate multiple energy, or false echoes, a multiples model (i.e., a model of the multiples) can be generated followed by subtraction of the multiples model from actual recorded seismic data. In such an approach, the multiples model may be generated synthetically or by one or more other techniques.

In multiples attenuation, adaptive subtraction is not necessarily a simple subtraction because models that are built can have different amplitudes, frequency range and phase compared to the actual recorded energy. In order to do an effective subtraction of recorded energy minus multiple model energy to equal primary energy only, the actual data and the multiples model is synchronized in amplitude, time, phase and frequency; adaptive subtraction in this context adapts the multiples model to match the recorded seismic to make the subtraction effective.

Various actions can be taken in adapting a multiples model, for example, consider a so-called match filter, which is a way of applying a filter to one set of values to make it more similar to another set of values. In such a context, the filter would be use to match the multiples model to the recording.

As explained, as to OBS denoising, hydrophone data can be utilized for model generation (e.g., noise model generation) whereby such a model can be applied via adaptive subtraction to reduce noise in geophone data. As explained, hydrophone data acquired by a water pressure sensor can be omnidirectional pressure data and geophone data acquired by a multi-component geophone can include shear information in two or more dimensions, generally orthogonal to P-waves recorded by the geophone where the two or more dimensions can correspond to an ocean bottom or other water bottom surface (e.g., a water-material interface). Hence, rather than attenuating multiples from multiples and primaries data, an OBS workflow can include using one-dimensional hydrophone data to attenuate noise in geophone data.

As explained, an OBS workflow that considers recorded pressure data on a hydrophone component as a noise model for subtraction from PS-wave data, can address one or more types of noise which would otherwise demand separate techniques to be properly addressed (e.g., attenuated). Hence, a hydrophone data-based approach can simplify noise attenuation in geophone data for OBS when compared to multi-step techniques. Further, such an approach can be easier to control in that there is no signal removal in denoising.

As explained, OBS data can be acquired with a pressure source in the water and 4-component sensors at the seabed. In such an example, the 4-component data include a scalar measurement of the pressure just above the seafloor (e.g., hydrophone data), along with a 3-component vector measurement of particle velocity or particle acceleration at the seabed (e.g., geophone data). The data recorded includes direct arriving and reflected P-waves from the subsurface, S-waves converted from P-waves in the subsurface (PS-waves), interface and guided waves as well as different types of noise. Generally, workflows are performed that separate the recorded P-wave and PS-wave data and then process the separated P-wave data and PS-wave data individually. In such workflows, after separation, unwanted wave modes and other noise are to be removed from each dataset (e.g., for PS-wave data, processing can include removal of pure P-wave energy).

As explained, a OBS workflow can include using hydrophone data to build a model of noise to be removed from PS-wave data where such a noise model can be adaptively subtracted from the PS-wave data. In such an example, within the adaptive subtraction process, a method can include analysis of signal leakage and signal protection.

As explained, OBS data includes both P-waves and converted waves (PS-waves) from the subsurface where such wave modes are commonly separated early in a processing sequence where different actions in processing like denoise and demultiple performed on separated data. For example, a workflow can process and use P-wave data while PS-wave data processed separately to provide some additional information on subsurface structure and reservoir properties.

As explained, a geophone can be a 3-component sensor that records seismic energy in three different directions (e.g., x, y and z), which may define vectors such that the geophone data can be referred to as vector data. Such vector data can be rotated such that one of the directions is vertical (e.g., aligned with gravity) to define a vertical component while the two other directions are horizontal to define horizontal components. As shear-waves do not travel in water, upcoming shear-waves are fully reflected into downgoing at the seabed (e.g., ocean bottom or water bottom). Therefore, according to some examples, almost all of the PS-wave energy is expected to be recorded in the horizontal components at the seabed; accordingly, the horizontal components are generally used for PS-wave processing.

At an interface between water and an ocean bottom (e.g., seabed or water bottom), there will be reflections and transmissions where the shear-waves are reflected at the ocean bottom when upgoing as they do not travel in water; however, there may be a relatively small amount of energy converted to P-waves and reflected or transmitted such that a reflected shear-wave may be slightly different from an upcoming shear-wave.

As to upcoming reflected P-waves, unless coming up perfectly vertical (e.g., at 90 degrees), they will have one or more horizontal components. As such P-wave related horizontal components are not PS-wave energy, the P-waves can be removed from the recorded horizontal components (e.g., x-component and y-component) to reduce noise in a PS-wave image. For some examples, the recorded horizontal components are used to generate at least one of a radial component and a transverse component. One or more other types of noise in one or more horizontal components (e.g., guided waves and Scholte waves) may also be removed or otherwise attenuated.

Again, as shear-waves do not travel in water, there will be no shear-waves recorded by a pressure measurement sensor (e.g., a hydrophone). Hence, the pressure sensor measurement can be regarded as a noise model for noise on the PS-wave data such that the noise model can be utilized to denoise the PS-wave data (e.g., generate noise attenuated PS-wave data).

To accommodate residual differences between the responses on the different components, including the relative angle or azimuth of the arrivals, the noise model can be adaptively subtracted from PS-wave data. Prior to this noise attenuation, different sensors can be calibrated to each other to minimize the amount of adapting demanded for the model. As an example, a one-step adaptive subtraction can also include analysis of potential PS-wave signal attenuated by the adaptive subtraction and incorporate one or more techniques designed to protect the data.

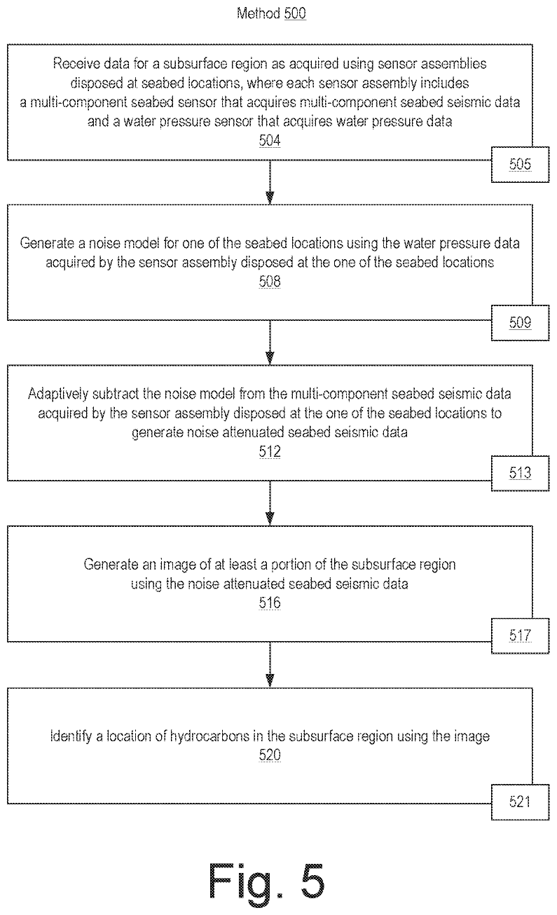

FIG. 5 shows a method 500 that includes a reception block 504 for receiving data for a subsurface region as acquired using sensor assemblies disposed at seabed locations, where each sensor assembly includes a multi-component seabed sensor that acquires multi-component seabed seismic data and a water pressure sensor that acquires water pressure data; a generation block 508 for generating a noise model for one of the seabed locations using the water pressure data acquired by the sensor assembly disposed at the one of the seabed locations; an adaptive subtraction block 512 for adaptively subtracting the noise model from the multi-component seabed seismic data acquired by the sensor assembly disposed at the one of the seabed locations to generate noise attenuated seabed seismic data; and a generation block 516 for generating an image of at least a portion of the subsurface region using the noise attenuated seabed seismic data. As shown, the method 500 can include an identification block 520 for identifying a location of hydrocarbons in the subsurface region using the image. For example, the image may be utilized to identify hydrocarbons and a location or locations of the hydrocarbons, which may form, for example, a reservoir (e.g., a hydrocarbon containing reservoir). Such a method may be part of the method 350 of FIG. 3.

The method 500 is shown in FIG. 5 in association with various computer-readable media (CRM) blocks 505, 509, 513, 517 and 521. Such blocks generally include instructions suitable for execution by one or more processors (or cores) to instruct a computing device or system to perform one or more actions. While various blocks are shown, a single medium may be configured with instructions to allow for, at least in part, performance of various actions of the method 500. A computer-readable medium (CRM) may be a computer-readable storage medium that is not a carrier wave, that is not a signal and that is non-transitory. The blocks may be provided as instructions such as the instructions 380 of the system 360 of FIG. 3.

In the example of FIG. 5, after generating the noise attenuated seabed seismic data, one or more processes may be performed prior to imaging. For example, consider multiple attenuation where one or more modes of multiples are attenuated. As an example, a framework such as the OMEGA framework may be utilized for one or more processes in a method such as the method 500 of FIG. 5. As an example, the OMEGA framework can include features or be operatively coupled to features that can perform noise model generation using hydrophone data and that can perform adaptive subtraction for denoising PS-wave data using a generated hydrophone data-based noise model.

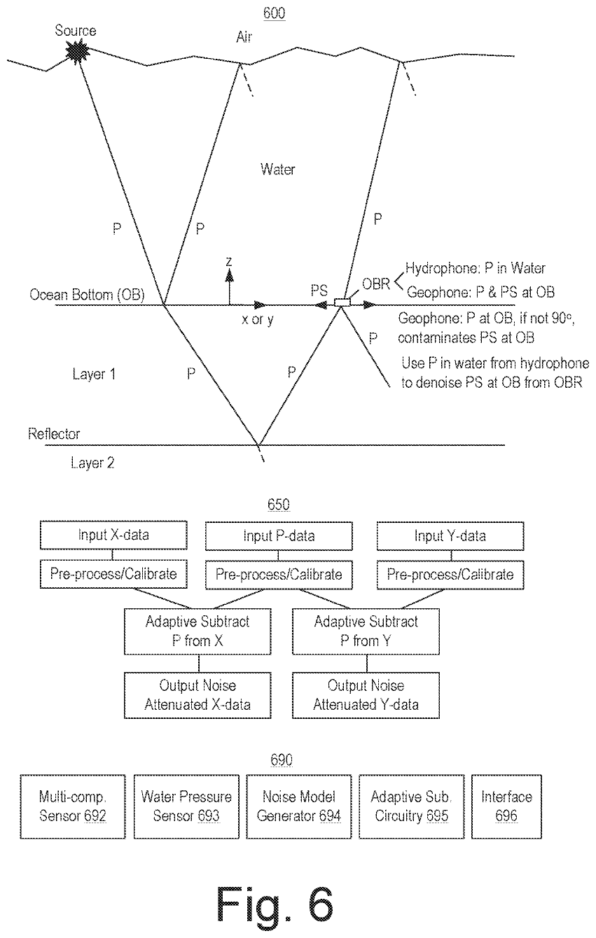

FIG. 6 shows an approximate example of an OBS scenario 600, an example of a method 650 that can provide for denoised data in one or more component directions, and an example of an assembly 690. As shown in the OBS scenario 600, a source can emit energy such that a P-wave travels through water to an ocean bottom (OB) where it can be in part reflected back into the water and in part transmitted into a layer labeled Layer 1. As shown, the transmitted part in Layer 1 can travel to a reflector (e.g., interface) between Layer 1 and another layer labeled Layer 2. In such an example, upgoing or upcoming P-wave energy as reflected by the reflector can reach the OB where an ocean bottom receiver (OBR) (e.g., a sensor assembly) can record P-wave energy and PS-wave energy and can record transmitted P-wave energy in the water, for example, using a hydrophone. In such an example, as the upcoming P-wave is not at 90 degrees to the OB, it contaminates the recorded PS-wave. As explained, the pressure wave energy recorded as pressure wave data by a water pressure sensor (e.g., a hydrophone) that is proximate to a sensor (e.g., a geophone) that records PS-wave can be utilized to attenuate noise (P-wave contamination) in the recorded PS-wave data. As explained, upcoming reflected P-waves, unless coming up perfectly vertical (e.g., normal to the OB), will have a component on the horizontal components. Such P-waves can be effectively removed from the horizontal components to thereby denoise PS-wave data.

As an example, properties, geometry, etc., of a subsurface region can be utilized for model generation. As an example, a method may include use of velocity information, layer properties, water properties, ray-tracing, energy conversion, etc., for model generation. As explained, a noise model based on water pressure data may be adjusted as part of an adaptive subtraction process. As an example, a noise model may be tuned prior to performing adaptive subtraction and/or water pressure data may be tuned (e.g., calibrated) prior to performing adaptive subtraction. As an example, a noise model may be renderable as an image such as, for example, a gather image. As an example, an adaptive subtraction process may be performed in one or more domains (e.g., time and/or space). As an example, an adaptive subtraction process may be performed using data renderable as images (e.g., an image of PS-wave data, an image of a noise model based on water pressure data, and an image of noise attenuated PS-wave data).

As explained, a sensor assembly can include a geophone and a hydrophone where they may be co-located. As the distance between the geophone and the hydrophone decreases, the hydrophone water pressure data may be more representative of noise in geophone data. As explained, some amount of distance exists as a geophone is effectively in contact with an ocean bottom while a hydrophone is effectively in contact with water. In various examples, a distance may be less than approximately 1 meter, noting that a distance may be as much as, for example, 10 meters while still providing for some amount of hydrophone data-based denoising of PS-wave data acquired by a geophone.

In the example of FIG. 6, the method 650 can include receiving data from a sensor assembly that includes geophone data and hydrophone data. For example, consider geophone data that includes x, y and z directions and hydrophone data as omnidirectional pressure data. As explained, hydrophone data can include information as to one or more horizontal components, which may appear as noise in the geophone data. In such an example, the method can input the P-data (e.g., P-wave data) as the hydrophone data for adaptive subtraction of noise from the geophone data. In the example of FIG. 6, the x component geophone data and the y component geophone data may be handled as separate data channels (e.g., separate components) where a noise model based on the P-data can include y noise that can be adaptively subtracted from the y component geophone data and include x noise that can be adaptively subtracted from the x component geophone data. In the example of FIG. 6, the output x-data (e.g., output noise attenuated x-data) and the output y-data (e.g., output noise attenuated y-data) are noise attenuated such that an image can be generated with lesser noise and hence greater accuracy. For some examples, this may also apply to any combination of components based on the horizontal component, such as the radial data, which is where the PS-data are processed in some cases and any non-horizontal dataset which includes PS-data.

As shown in FIG. 6, the assembly 690 may be a seabed sensor assembly that may include a multi-component seabed sensor 692 that acquires multi-component seabed seismic data; a water pressure sensor 693 that acquires water pressure data; noise model generation circuitry 694 that generates a noise model using the water pressure data; adaptive subtraction circuitry 695 that adaptively subtracts the noise model from the multi-component seabed seismic data to generate noise attenuated seabed seismic data; and an interface 696 for transmission of the noise attenuated seabed seismic data. As an example, a system may include one or more assemblies. As an example, a system may be a distributed system. As an example, a system may be a localized system. As an example, a system may include one or more local components and one or more remote components.

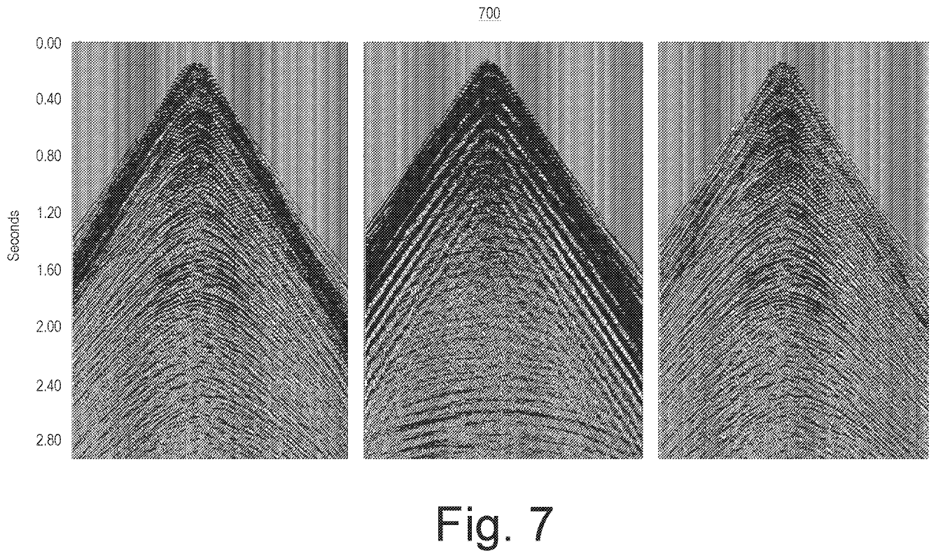

FIG. 7 shows example images 700, which include input horizontal data (left) from a geophone from the Volve field data village used under the terms and conditions from Equinor and the former license partners, a noise model (middle) from water pressure data (e.g., hydrophone data), and horizontal data after denoise (right). Specifically, FIG. 7 shows a seismic gather with the horizontal component before the noise attenuation on the left, the hydrophone data which forms the noise model in the middle and then the horizontal component after adaptive noise subtraction on the left. In the images 700, the strong early arrival which is not converted wave signal is clearly visible on the input data and noise, but largely attenuated (e.g., largely removed) on the data after noise suppression. The reflected P-wave energy which is tends to be quite clear on the noise model is also attenuated from the data.

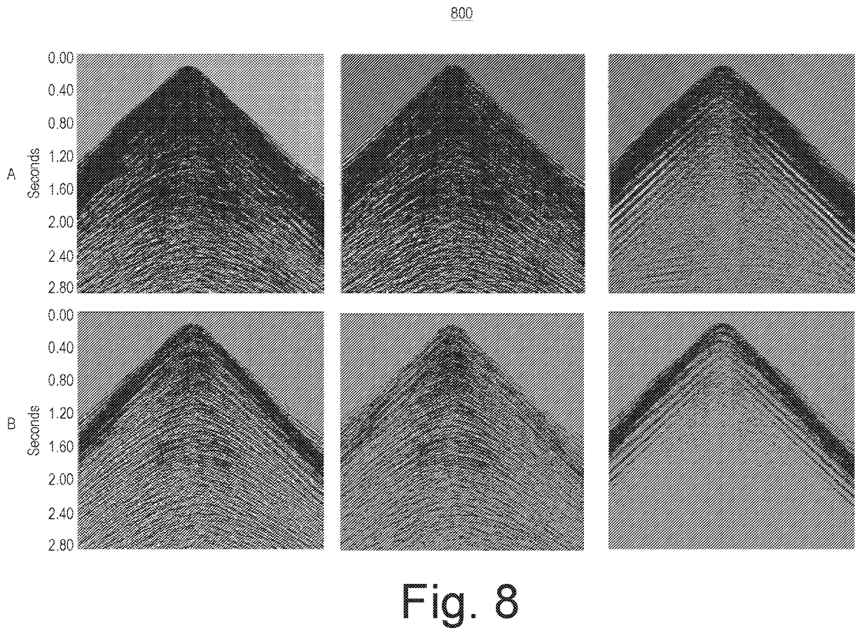

FIG. 8 shows example images 800, which include input horizontal data (left), horizontal data after denoise (middle) the Volve field data village used under the terms and conditions from Equinor and the former license partners, noise subtracted (right) displayed with two different scalings (upper row scaling A and lower row scaling B). As explained with respect to FIG. 7, the reflected P-wave energy which is very clear on the noise model is also attenuated from the data. However, this is clearer on the gathers in FIG. 8 as demonstrated by what has been removed. In FIG. 8, the horizontal data are displayed before and after noise suppression (left and middle) where the noise removed is to the right. Here one can clearly see that reflected P-wave energy has been removed by the small moveout events on the removed noise compared to the higher moveout converted wave signal on the data after noise suppression. As the traces in these gather displays have different source to receiver distances, with the smallest distance in the middle, the incident angle at the receiver will vary. For the small offset, the P-waves travel close to vertical and hence the horizontal component of the P-waves recorded on horizontal sensors are small.

The Volve field is in the central part of the North Sea, five kilometers north of the Sleipner Øst field. The water depth is approximately 80 meters. The Volve field was discovered in 1993, and the plan for development and operation (PDO) was approved in 2005. The Volve field was developed with a jack-up processing and drilling facility. The vessel “Navion Saga” was used for storing stabilized oil; where production started in 2008. The Volve field reservoir produced oil from sandstone of Middle Jurassic age in the Hugin Formation. The Volve field reservoir is generally within a depth of approximately 2700 to approximately 3100 meters. The western part of the structure tends to be heavily faulted where communication across the faults may be in various regions uncertain. As to a recovery strategy, production was achieved at least in part through water injection (e.g., for pressure support, etc.). The Volve field data are provided as an example to indicate how improved seismic imaging may be utilized to assess, develop and/or produce from a field (e.g., a reservoir). As explained, various decisions, operations, etc., depend on seismic imaging to elucidate the extent of a reservoir and/or structural features of a reservoir and/or its surroundings. As explained, fractures, faults, etc., may be relevant structural features that may or may not provide for fluid communication. Such structural features may become more readily ascertainable where seismic imaging is improved. As explained, various field operations can depend on seismic imaging; hence, improved seismic imaging can improve field operations (e.g., drilling of wells, placement of producer wells, placement of injector wells, etc.). As an example, various types of characterizations may be performed using seismic imaging. For example, in addition to structural and/or fluid features (e.g., in terms of spatial locations, etc.), seismic imaging may provide a basis for determining petrophysical properties of subsurface materials, which may be utilized for modeling, development, operations, etc. Hence, improved seismic imaging may provide for improvement to various types of workflows, field operations, etc.

As explained, in processing PS-wave data it is desirable to remove recorded noise. As an example, at least some of this noise can be removed by using a measured pressure component in water as a noise model and performing adaptive subtraction. As shown in the example method 600 of FIG. 6, different sensor types can be used and calibrated to a common instrument response. A method such as the method 500 of FIG. 5 can be implemented to replace multiple steps in an existing workflow along with facilitating checking and controlling signal leakage from denoise, which can provide for adjustments as may be appropriate. Various techniques may be applied to one or more types of data that include PS-waves.

As an example, a method can include receiving data for a subsurface region as acquired using sensor assemblies disposed at seabed locations, where each sensor assembly includes a multi-component seabed sensor that acquires multi-component seabed seismic data and a water pressure sensor that acquires water pressure data; generating a noise model for one of the seabed locations using the water pressure data acquired by the sensor assembly disposed at the one of the seabed locations; adaptively subtracting the noise model from the multi-component seabed seismic data acquired by the sensor assembly disposed at the one of the seabed locations to generate noise attenuated seabed seismic data; and generating an image of at least a portion of the subsurface region using the noise attenuated seabed seismic data. In such an example, the noise attenuated seabed seismic data can be noise attenuated shear-wave data.

As an example, sensor assemblies can be ocean bottom nodes (OBNs) and/or ocean bottom cables (OBCs). As an example, a sensor assembly may be an ocean bottom receiver (OBR).

As an example, a multi-component seabed sensor can be a geophone and a water pressure sensor can be a hydrophone.

As an example, a distance between a multi-component seabed sensor and a water pressure sensor can be less than approximately 10 meters and, for example, less than approximately 1 meter.

As an example, a method can include calibrating a multi-component seabed sensor and a water pressure sensor. In such an example, calibrating can include aligning a vertical component of the multi-component seabed seismic data with gravity or to be substantially normal to a water bottom. In such an example, adaptively subtracting can attenuate noise in one or more components of the multi-component seabed seismic data that are orthogonal to the vertical component.

As an example, a method can include adaptively subtracting a first selected component of multi-component seabed seismic data and separately adaptively subtracting a second selected component of the multi-component seabed seismic data. In such an example, the components can be utilized, as noise attenuated components, for generating an image (e.g., a PS-wave image).

As an example, a method can include adaptively subtracting individual horizontal components of multi-components of the multi-component seabed seismic data. For example, in a Cartesian coordinate system, a seabed (e.g., water bottom or ocean bottom) may be considered to be a relatively flat surface at a location of a sensor assembly where x, y-components, as well as radial and transverse components, can define a plane of the surface where a z-component can be normal to the plane.

As an example, a noise model can represent P-wave energy at a seabed location from an upcoming P-wave. As explained, if an upcoming P-wave does not approach a seabed at a normal angle, it may cause contamination in PS-wave data.

As an example, a method can include identifying a location of hydrocarbons in a subsurface region using a PS-wave image that has been generated using noise attenuated PS-wave data (e.g., via use of a water pressure data-based noise model).

As an example, a system can include a processor; memory operatively coupled to the processor; and processor-executable instructions stored in the memory to instruct the system to: receive data for a subsurface region as acquired using sensor assemblies disposed at seabed locations, where each sensor assembly includes a multi-component seabed sensor that acquires multi-component seabed seismic data and a water pressure sensor that acquires water pressure data; generate a noise model for one of the seabed locations using the water pressure data acquired by the sensor assembly disposed at the one of the seabed locations; adaptively subtract the noise model from the multi-component seabed seismic data acquired by the sensor assembly disposed at the one of the seabed locations to generate noise attenuated seabed seismic data; and generate an image of at least a portion of the subsurface region using the noise attenuated seabed seismic data.

As an example, a seabed sensor assembly can include a multi-component seabed sensor that acquires multi-component seabed seismic data; a water pressure sensor that acquires water pressure data; noise model generation circuitry that generates a noise model using the water pressure data; adaptive subtraction circuitry that adaptively subtracts the noise model from the multi-component seabed seismic data to generate noise attenuated seabed seismic data; and an interface for transmission of the noise attenuated seabed seismic data. In such an example, the seabed sensor assembly can include a power source.

As an example, a seabed sensor assembly can include a distance between a multi-component seabed sensor and a water pressure sensor that is less than 10 meters and, for example, less than 1 meter.

As an example, noise model generation circuitry can include a processor and memory and, for example, appropriate instructions stored in the memory. As an example, adaptive subtraction circuitry can include a processor and memory and, for example, appropriate instructions stored in the memory.

As an example, a seabed sensor assembly can include a housing and a base, where a multi-component seabed sensor is coupled to the base for seabed seismic sensing and where a water pressure sensor is disposed a distance from the base for water pressure sensing.

A system may include one or more modules (e.g., sets of instructions), which may be provided to analyze data, control a process, perform a task, perform a workstep, perform a workflow, etc.

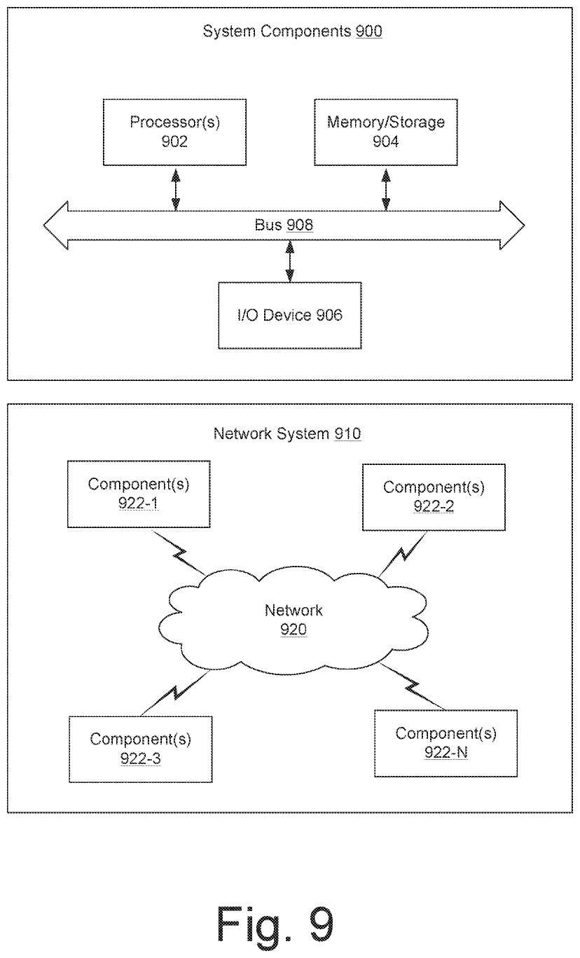

FIG. 9 shows components of a computing system 900 and a networked system 910 that includes a network 920. The system 900 includes one or more processors 902, memory and/or storage components 904, one or more input and/or output devices 906 and a bus 908. Instructions may be stored in one or more computer-readable media (memory/storage components 904). Such instructions may be read by one or more processors (see the processor(s) 902) via a communication bus (see the bus 908), which may be wired or wireless. The one or more processors may execute such instructions to implement (wholly or in part) one or more attributes (as part of a method). A user may view output from and interact with a process via an I/O device (see the device 906). A computer-readable medium may be a storage component such as a physical memory storage device such as a chip, a chip on a package, a memory card, etc. (a computer-readable storage medium).

Components may be distributed, such as in the network system 910. The network system 910 includes components 922-1, 922-2, 922-3, . . . 922-N. The components 922-1 may include the processor(s) 902 while the component(s) 922-3 may include memory accessible by the processor(s) 902. Further, the component(s) 922-2 may include an I/O device for display and optionally interaction with a method. The network may be or include the Internet, an intranet, a cellular network, a satellite network, etc.

A device may be a mobile device that includes one or more network interfaces for communication of information. A mobile device may include a wireless network interface (operable via IEEE 802.11, ETSI GSM, BLUETOOTH®, satellite, etc.). A mobile device may include components such as a main processor, memory, a display, display graphics circuitry (optionally including touch and gesture circuitry), a SIM slot, audio/video circuitry, motion processing circuitry (accelerometer, gyroscope), wireless LAN circuitry, smart card circuitry, transmitter circuitry, GPS circuitry, and a battery. A mobile device may be configured as a cell phone, a tablet, etc. A method may be implemented (wholly or in part) using a mobile device. A system may include one or more mobile devices.

A system may be a distributed environment such as a so-called “cloud” environment where various devices, components, etc. interact for purposes of data storage, communications, computing, etc. A device or a system may include one or more components for communication of information via one or more of the Internet (where communication occurs via one or more Internet protocols), a cellular network, a satellite network, etc. A method may be implemented in a distributed environment (wholly or in part as a cloud-based service).

Information may be input from a display (consider a touchscreen), output to a display or both. Information may be output to a projector, a laser device, a printer, etc. such that the information may be viewed. Information may be output stereographically or holographically. As to a printer, consider a 2D or a 3D printer. A 3D printer may include one or more substances that can be output to construct a 3D object. Data may be provided to a 3D printer to construct a 3D representation of a subterranean formation. Layers may be constructed in 3D (horizons, etc.), geobodies constructed in 3D, etc. Holes, fractures, etc., may be constructed in 3D (as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving data for a subsurface region as acquired using sensor assemblies disposed at seabed locations, each sensor assembly includes a multi-component seabed sensor that acquires multi-component seabed seismic data and a water pressure sensor that acquires water pressure data;
generating a noise model for one of the seabed locations using the water pressure data acquired by the sensor assembly disposed at the one of the seabed locations;
adaptively subtracting the noise model from the multi-component seabed seismic data acquired by the sensor assembly disposed at the one of the seabed locations to generate noise attenuated seabed seismic data; and
generating an image of at least a portion of the subsurface region using the noise attenuated seabed seismic data.

2. The method of claim 1, wherein the noise attenuated seabed seismic data are noise attenuated shear-wave data.

3. The method of claim 1, wherein the sensor assemblies include ocean bottom nodes or ocean bottom cables.

4. The method of claim 1, wherein the multi-component seabed sensor includes a geophone.

5. The method of claim 1, wherein the water pressure sensor includes a hydrophone.

6. The method of claim 1, wherein a distance between the multi-component seabed sensor and the water pressure sensor is less than 10 meters.

7. The method of claim 1, comprising calibrating the multi-component seabed sensor and the water pressure sensor.

8. The method of claim 7, wherein the calibrating includes aligning a vertical component of the multi-component seabed seismic data with gravity.

9. The method of claim 8, wherein the adaptively subtracting attenuates noise in one or more components of the multi-component seabed seismic data that are orthogonal to the vertical component.

10. The method of claim 1, wherein the adaptively subtracting includes adaptively subtracting a first selected component of the multi-component seabed seismic data and separately adaptively subtracting a second selected component of the multi-component seabed seismic data.

11. The method of claim 1, wherein the adaptively subtracting includes adaptively subtracting, individual horizontal components of the multi-components of the multi-component seabed seismic data.

12. The method of claim 1, wherein the noise model represents P-wave energy at the one of the seabed locations from an upcoming P-wave.

13. The method of claim 1, comprising identifying a location of hydrocarbons in the subsurface region using the image.

14. A system comprising:
a processor;
memory operatively coupled to the processor; and
processor-executable instructions stored in the memory to instruct the system to:
receive data for a subsurface region as acquired using sensor assemblies disposed at seabed locations, each sensor assembly includes a multi-component seabed sensor that acquires multi-component seabed seismic data and a water pressure sensor that acquires water pressure data;
generate a noise model for one of the seabed locations using the water pressure data acquired by the sensor assembly disposed at the one of the seabed locations;
adaptively subtract the noise model from the multi-component seabed seismic data acquired by the sensor assembly disposed at the one of the seabed locations to generate noise attenuated seabed seismic data; and
generate an image of at least a portion of the subsurface region using the noise attenuated seabed seismic data.

15. A seabed sensor assembly comprising:
a multi-component seabed sensor that acquires multi-component seabed seismic data;
a water pressure sensor that acquires water pressure data;
noise model generation circuitry that generates a noise model using the water pressure data;
adaptive subtraction circuitry that adaptively subtracts the noise model from the multi-component seabed seismic data to generate noise attenuated seabed seismic data; and
an interface for transmission of the noise attenuated seabed seismic data.

16. The seabed sensor assembly of claim 15, comprising a power source.

17. The seabed sensor assembly of claim 15, wherein a distance between the multi-component seabed sensor and the water pressure sensor is less than 10 meters.

18. The seabed sensor assembly of claim 15, wherein the noise model generation circuitry includes a processor and memory.

19. The seabed sensor assembly of claim 15, wherein the adaptive subtraction circuitry includes a processor and memory.

20. The seabed sensor assembly of claim 15, comprising a housing and a base, the multi-component seabed sensor is coupled to the base for seabed seismic sensing and the water pressure sensor is disposed a distance from the base for water pressure sensing.
